(19) United States
(12) Patent Application Publication
(10) Pub. No.: US 2006/0185798 A1
(43) Pub. Date: Aug. 24, 2006

(54) Flexible laminae handling apparatus

(76) Inventors: Alex Morgan, Borrowash (GB); Mark Smith, Groby (GB); Riaz Sayani, Leicester (GB)

Correspondence Address: FISH & RICHARDSON PC, P.O. BOX 1022, MINNEAPOLIS, MN, 55440-1022, US

(21) Appl. No.: 11/347,030

(22) Filed: Feb. 3, 2006

(30) Foreign Application Priority Data
Feb. 8, 2005 (GB) 0502522.6

(51) Int. Cl. B65C 9/26; B65C 9/36

(52) U.S. Cl. 156/542; 156/540; 156/541; 156/DIG. 37; 156/DIG. 42

(57) ABSTRACT

An apparatus for handling flexible laminae includes a laminae receiving surface having a plurality of openings which are connected to a negative pressure source, means to feed a lamina across the laminae receiving surface in a feed direction A such that the lamina is retained by suction afforded by the negative pressure acting on a part of the lamina which overlies at least some of the openings of the surface, characterised in that the laminae receiving surface includes first and second parts which are relatively inclined to one another about a line which extends generally in the direction of laminae feed.

### BACKGROUND TO THE INVENTION

This invention relates to a flexible laminae handling apparatus and more particularly but not exclusively to an apparatus for handling self-adhesive labels which have been removed from a backing member and which are about to be applied to an object.

Such apparatus are used in packaging lines, and may include a print head to print information onto the labels before they are applied to the object.

### DESCRIPTION OF THE PRIOR ART

Label handling apparatus are known which include a housing which is connected to a negative pressure source, the housing having a planar surface with openings, e.g. an apertured or foraminous plate. A label is fed in a feed direction across the surface, typically as it is removed from its backing member e.g. by a peeler bar or the like, and the label is retained in a position ready for application to the object, by suction afforded by the negative pressure in the housing acting on a part of the label which overlies at least some of the openings of the surface.

Such apparatus operate well for small labels such thus the extent of each label which does not overlie the surface and extends beyond a periphery of the surface in the direction of label feed, is small. Thus the extending part of the label is self supporting.

For larger labels, and particularly but not exclusively labels which are long in the feed direction such that a long length of the label extends beyond the periphery of the label receiving surface, it has been found that the extending label parts may not be adequately self supporting and as a result, as the labels are applied to their objects, creasing can result, which is undesirable.

### SUMMARY OF THE INVENTION

According to a first aspect of the invention we provide an apparatus for handling flexible laminae, the apparatus including a laminae receiving surface having a plurality of openings which are connected to a negative pressure source, means to feed a lamina across the laminae receiving surface in a feed direction such that the lamina is retained by suction afforded by the negative pressure acting on a part of the lamina which overlies at least some of the openings of the surface, characterised in that the laminae receiving surface includes first and second parts which are relatively inclined to one another about a line which extends generally in the direction of laminae feed.

Thus whereas in prior proposals, the laminae receiving surface has been planar in an attempt to maintain a retained lamina flat, in accordance with the invention, the laminae receiving surface is not planar, but rather the suction through openings in each of the first and second laminae receiving surface parts, will cause a retained lamina to adopt a non-planar configuration thus imparting rigidity to a self supporting part of the retained lamina. It has been found that where the invention is applied to an apparatus for applying self-adhesive labels, the invention results in less creasing of labels applied to objects.

Most preferably, the laminae receiving surface parts are each relatively inclined in a direction away from a plane along which the laminae are fed to the laminae receiving surface. Preferably both laminae receiving surface parts are inclined to the laminae feed plane

Each laminae receiving surface part may itself be generally planar, with preferably, an included angle between the relatively inclined surface parts of between 175° and 155°, and more preferably in the order of 160°. However to some extent the optimum angle will depend upon the size of the laminae being handled, and the flexibility of the laminae. Preferable both laminae receiving surface parts are inclined to the plane along which the laminae are fed to the laminae receiving surface.

The surface parts may each include slots which preferably extend generally in the direction of laminae feed, the openings being provided in the slots. Such a slot may be provided along the line between the relatively inclined first and second laminae receiving surface parts.

Although each slot may individually or in groups, be connected to the negative pressure source, preferably the laminae receiving surface provides a side, or part of a side of a sealed housing which is connected to the negative pressure source.

The apparatus may be a label handling apparatus, for example for handling self adhesive labels which are fed towards the laminae receiving surface on a backing member, such as a web of material from which the labels are removed just prior to being fed onto the label receiving surface with the adhesive sides of the labels facing away from the laminae receiving surface, and are retained by the suction at the label receiving surface ready for application to an object. For example, the laminae handling apparatus may be provided adjacent to a conveying apparatus which conveys objects towards the laminae handling apparatus, and into contact with a self supporting label part which when the label is retained, extends beyond a periphery of the laminae receiving surface in the laminae feed direction. The apparatus may further include a label applicator which acts to wipe the retained label onto the object as the object is conveyed past the laminae handling apparatus, thus releasing the label from the laminae receiving surface.

In such an arrangement, typically the plane along which the laminae are fed onto the laminae receiving surface is generally upright, but may be other orientations.

However the invention may be applied to other label handling apparatus and to any other apparatus for handling flexible laminae which are retained to the surface by suction to a laminae receiving surface for any desired purpose, such as to await some work operation.

According to a second aspect of the invention we provide a system including a conveying apparatus for conveying objects to a label applying station, a laminae handling apparatus of the first aspect of the invention at the label applying station, the laminae handling apparatus being positioned relative to the conveying apparatus such that the laminae handling apparatus in use, retains a label where an object will engage the label as the object is conveyed to remove the label from the laminae receiving surface of the laminae handling apparatus as the object is conveyed past the label handling apparatus.

According to a third aspect of the invention we provide a method of handling a flexible lamina using a laminae handling apparatus including a laminae receiving surface having a plurality of openings which are connected to a negative pressure source, the method including feed the lamina across the laminae receiving surface in a feed direction such that the lamina is retained by suction afforded by the negative pressure acting on a part of the lamina which overlies at least some of the apertures of the plate, continuing to feed the lamina in the feed direction until a part of the lamina extends beyond a periphery of the laminae receiving surface characterised in that the method includes causing a retained lamina to adopt a non-planar configuration thus imparting rigidity to the part of the retained lamina extending beyond the surface periphery.

### BRIEF DESCRIPTION OF THE DRAWINGS

Embodiments of the invention will now be described with reference to the accompanying drawings in which:—

FIG. 1 is a plan illustrative view of a system including a conveying apparatus and a laminae handling apparatus in accordance with the invention;

FIG. 2 is an enlarged side view of part of the laminae handling apparatus of FIG. 1, showing a retained lamina;

FIG. 3 is a illustrative enlarged perspective view of the part of the apparatus shown in FIG. 2 and an additional part of the apparatus.

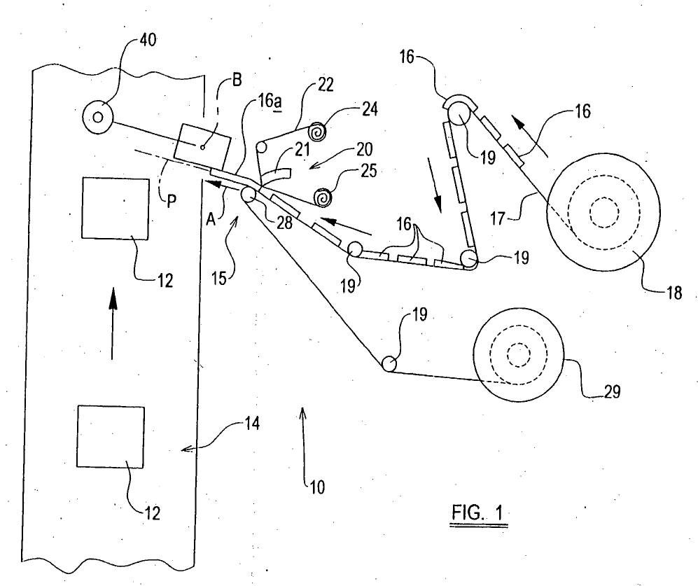

### DESCRIPTION OF THE PREFERRED EMBODIMENTS

Referring to the drawings, a system 10 for handling and applying labels 16 to objects 12 is illustrated. The system 10 includes a conveyor apparatus 14 which conveys a succession of objects 12 severally in this example, towards and past a label applying station 15 where the labels 16 are prepared for application to the objects 12, and applied.

In this example, the objects 12 are boxes, but in another example could be pallets, or any other object to which it is desired to apply a label 16.

The labels 16 are provided on a backing member 17, which in this example is a continuous web supplied on a supply spool 18 from which the backing member 17 and labels 16 are unwound. The backing member 17 and labels are fed via a series of rollers 19 along a feed path to a printing station 20 where there is a print head 21 for printing information on the labels 16. In this example, the print head 21 is a thermal transfer print head which includes a plurality of individually addressable and energisable heating elements which are selectively energised under computer control, to remove pixels of marking medium from a carrier ribbon 22 which is moved past the print head 21 with the labels 16, to effect printing of desired information. The carrier ribbon 22 is provided on a supply spool 24 and as it is used, is wound onto a take-up spool 25.

However the invention may be applied where other kinds of print heads 21 are provided, or indeed no print head or the like is provided in which case the labels 16 may be blank e.g. see through protective sheets, and/or the labels 16 may be pre-printed with information.

In the example illustrated, immediately after printing at the printing station 20, the backing member 17 passes around a peel bar or peel roller 28, undergoing a sharp turn such that the self adhesive labels 16 are peeled from the backing member 17 Thus the backing member 17 may pass to a take-up spool 29, whilst the labels 16 are fed in a feed direction A, in a generally upright orientation in this example, but in any event in a feed plane P, towards the conveyor apparatus 14.

It will be appreciated that a label 16 thus fed needs to await the arrival of an object 12 to which the label 16 is to be applied. Thus the label 16 needs to be retained in a ready condition for application.

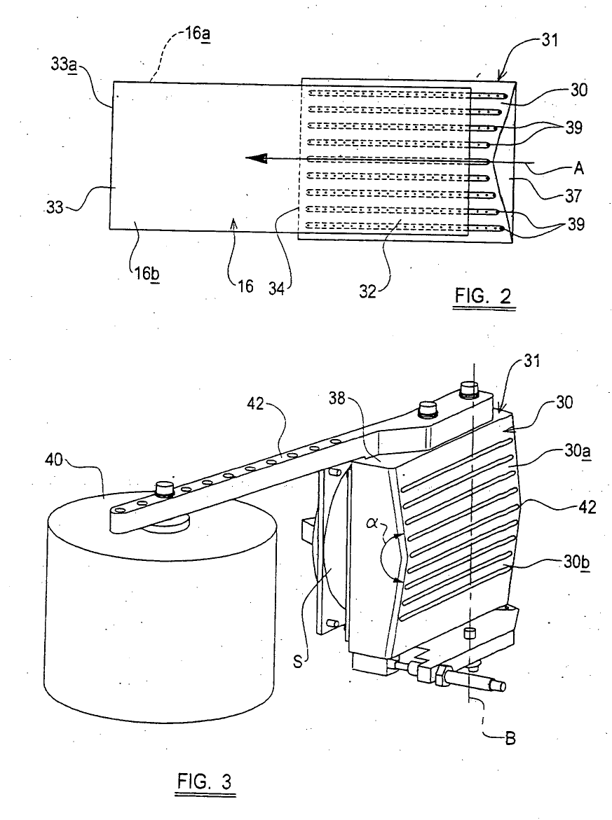

Referring particularly to FIGS. 2 and 3, a label 16 is shown in such a retained condition. The printed side 16a of the label 16 has been fed across a label receiving surface 30 of a label handling apparatus 31, such that part 32 of the label 16 overlies the surface 30, whilst a leading part 33 of the label 16 extends beyond a periphery 34 of the surface 30, in the feed direction A. The adhesive side 16b of the label 16 faces away from the label receiving surface 30.

The label handling apparatus 31 is of the kind including a plurality of openings in the label receiving surface 30. For example the surface 30 could be apertured or otherwise foraminous. In each case, the surface 30 is provided by a side of a generally sealed housing 38 which is connected in use to a sources of negative pressure, such as a fan as shown. Thus air is sucked through the openings developing suction to act on the part 32 of the label 16 which overlies the openings, thus to retain the label 16 relative to the label receiving surface 30 in the orientation shown.

It can be seen that a periphery of the housing 38 closest to the peeler bar or roller 28, has a chamfer 37 to aid the smooth feeding of the labels 16 onto the label receiving surface 30.

In this example, the label receiving surface 30 includes a plurality of slots 39 which extend in the direction of label feed, and the opening through which suction is developed, are provided in the slots 39. Thus in the event of a label 16 overlying all of the openings in the surface 30, air may still pass into the housing 38 so that the label 16 is not retained with such force that it cannot readily be released for application to its object 16 as will now be described. However, in another example, if desired, when it is desired to apply a retained label 16, the suction may temporarily be disrupted, readily to allow the label 16 to be released.

With the label 16 retained relative to the label receiving surface 30 as shown in FIG. 2, it will be appreciated that the part 33 of the label 16 which extends beyond the periphery 34 of the surface 30, or at least the leading edge 33a of the label 16, will lie in the path of the approaching object 12.

As the object 12 reaches the label applying station 15, the object will engage the leading edge 33a of the adhesive side 16b of the label 16 and as the object 12 is continued to be conveyed, the object 12 will begin to draw the label 16 further across and from the label receiving surface 30.

In the example illustrated, a label applicator 40 is provided which in this example is a foam covered roller, which acts to wipe the retained label 16 onto the object 12 as the object 12 is conveyed past the label applying station 15, thus further facilitating release of the label 16 from the label receiving surface 30.

The roller 40 is attached to the housing 38 by an arm 42, and the housing 38 is rotatable about a rotational axis B generally parallel to the feed direction A to facilitate label 16 release. The roller 40 may wipe the label 16 around a corner of the object 12 so that the (long) label may be applied to more than one object 12 side.

It will be appreciated that particularly where the label 16 is long in the feed direction A, such that the length of the label part 33 extending beyond the periphery 34 of the surface 30 is long, as the label 16 is flexible 16 and where planar, at least the self supporting leading part 33 of the label 16 could sag, which could result in the labels 16 creasing as it is applied to its object 12. This problem is particularly but not exclusively a concern with an apparatus 31 in which the label 16 is generally upright during handling and application to an object 12, but may occur to a greater degree in apparatus 31 where the labels 16 may be generally horizontal when handled and applied.

In accordance with the invention, when retained at the label receiving surface 30, the labels 16 are caused to adopt a non-planar configuration, thus imparting rigidity to the labels 16 and reducing the likelihood of creasing as the labels 16 are applied to their objects 12.

This is simply achieved in the label handling apparatus 31 by virtue of the label receiving surface 30 having first and second surface parts 30a, 30b which are relatively inclined about a line 42 which is generally parallel with the label feed direction A. Desirably, the line 42 is at a position such that it will coincide with a half height position on each label 16 and a slot 39 is provided along the line 42.

In the example shown, the first and second surface parts 30a, 30b are each inclined away from the plane P in which the label 16 is fed to the label receiving surface 30, with an included angle α of about 160° between them. However, the included angle could be in the range 175° to 155° or outside this range, the optimum angle being chosen depending upon the relative sizes of the labels 16 and label receiving surface 30, and the flexibility of the labels 16. It will be appreciated that due to the suction at the label receiving surface 30, the labels 16 will be drawn into a non-planar configuration thus adding depth and thus imparting rigidity to the labels 16. Preferably the included angle α is not so small that there is any risk of creasing the labels 16 as they are drawn to the two parts 30a, 30b of the receiving surface 30.

The retained label 16 thus adopts a curved configuration, the curvature of which may decrease along the self supporting part 33 of the label 16 away from the periphery 34 of the label receiving surface 30 in the feed direction A. In another example, the labels 16 could be caused to adopt a more complex non-planar configuration.

In another example, which is not preferred, only one of the receiving surface parts 30a, 30b may be inclined relative to the feed plane P, or one or both receiving surface part 30a, 30b may be inclined towards the feed plane P, but with the geometry at the label applying station 15 described, this would mean that the corners of the leading edge 33a of the label part 33 extending beyond the periphery 34 of the label receiving surface 30 would be closer together than when applied to the object 12, which could encourage creasing.

However with a different geometry, this alternative may be viable.

Various modifications in addition to those already suggested, may be adopted without departing from the scope of the invention.

The invention has been specifically described in relation to a label handling and applying system 10, but may be applied wherever it is required to handle a flexible lamina using a laminae receiving surface which retains at least part of a label 16 to it by establishing suction through openings, usually where part of the laminae extends beyond the periphery of the laminae receiving surface and thus is self-supporting.

1. An apparatus for handling flexible laminae, the apparatus including a laminae receiving surface having a plurality of openings which are connected to a negative pressure source, means to feed a lamina across the laminae receiving surface in a feed direction such that the lamina is retained by suction afforded by the negative pressure acting on a part of the lamina which overlies at least some of the openings of the surface, characterised in that the laminae receiving surface includes first and second parts which are relatively inclined to one another about a line which extends generally in the direction of laminae feed.

2. An apparatus according to claim 1 wherein a retained lamina adopts a non-planar configuration thus imparting rigidity to a self supporting part of the retained lamina.

3. An apparatus according to claim 1 wherein the laminae receiving surface parts are each relatively inclined in a direction away from a plane along which the laminae are fed to the laminae receiving surface.

4. An apparatus according to claim 1 wherein each laminae receiving surface part is generally planar.

5. An apparatus according to claim 4 wherein the relatively inclined laminae receiving surface parts have an included angle between them of between 175° and 155°.

6. An apparatus according to claim 5 wherein the relatively inclined laminae receiving surface parts have an inclined angle between them in the order of 160°.

7. An apparatus according to claim 4 wherein both laminae receiving surface parts are inclined to the plane along which the laminae are fed to the laminae receiving surface.

8. An apparatus according to claim 1 wherein the surface parts each include slots which extend generally in the direction of laminae feed, the openings being provided in the slots.

9. An apparatus according to claim 8 wherein a slot may be provided along the line between the relatively inclined first and second laminae receiving surface parts.

10. An apparatus according to claim 1 wherein the laminae receiving surface provides one of a side and a part of a side of a sealed housing which is connected to the negative pressure source.

11. An apparatus according to claim 1 wherein the apparatus is a label handling apparatus, for handling labels which are retained by the suction at the label receiving surface ready for application to an object.

12. An apparatus according to claim 11 wherein the laminae handling apparatus is provided adjacent to a conveying apparatus which conveys objects towards the laminae handling apparatus, and into contact with a self supporting label part which when the label is retained, extends beyond a periphery of the laminae receiving surface in the laminae feed direction.

13. An apparatus according to claim 12 wherein the apparatus further includes a label applicator which acts to wipe the retained label onto the object as the object is conveyed past the laminae handling apparatus, thus releasing the label from the laminae receiving surface.

14. An apparatus according to claim 11 wherein the labels are self-adhesive labels which are fed towards the laminae receiving surface on a backing member from which the labels are removed just prior to being fed onto the label receiving surface, with the adhesive sides of the labels facing away from the laminae receiving surface.

15. An apparatus according to claim 11 wherein the plane along which the laminae are fed onto the laminae receiving surface is generally upright.

16. A system including a conveying apparatus for conveying objects to a label applying station and at the label applying station, a laminae handling apparatus, the label handling apparatus including laminae receiving surface having a plurality of openings which are connected to a negative pressure source, means to feed a lamina across the laminae receiving surface in a feed direction such that the lamina is retained by suction afforded by the negative pressure acting on a part of the lamina which overlies at least some of the openings of the surface, characterised in that the laminae receiving surface includes first and second parts which are relatively inclined to one another about a line which extends generally in the direction of laminae feed, the laminae handling apparatus being positioned relative to the conveying apparatus such that the laminae handling apparatus in use, retains a label where an object will engage the label as the object is conveyed to remove the label from the laminae receiving surface of the laminae handling apparatus as the object is conveyed past the label handling apparatus.

17. A method of handling a flexible lamina using a laminae handling apparatus including a laminae receiving surface having a plurality of openings which are connected to a negative pressure source, the method including feed the lamina across the laminae receiving surface in a feed direction such that the lamina is retained by suction afforded by the negative pressure acting on a part of the lamina which overlies at least some of the apertures of the plate, continuing to feed the lamina in the feed direction until a part of the lamina extends beyond a periphery of the laminae receiving surface characterised in that the method includes causing a retained lamina to adopt a non-planar configuration thus imparting rigidity to the part of the retained lamina extending beyond the surface periphery.
